(19) United States
(12) Patent Application Publication
(10) Pub. No.: US 2017/0024433 A1
(43) Pub. Date: Jan. 26, 2017

(54) QUERY PLAN POST OPTIMIZATION ANALYSIS AND REOPTIMIZATION

(71) Applicant: HEWLETT PACKARD ENTERPRISE DEVELOPMENT LP, Houston, TX (US)

(72) Inventors: Ravisha Neelakanthappa, Austin, TX (US); Qifan Chen, Austin, TX (US)

(21) Appl. No.: 15/302,826

(22) PCT Filed: Apr. 29, 2014
(86) PCT No.: PCT/US2014/035908

§ 371 Date: Oct. 7, 2016

(51) Int. Cl. G06F 17/30

(52) U.S. Cl. CPC G06F 17/30442; G06F 17/3033

(57) ABSTRACT

Query plan post optimization analysis and reoptimization can include analyzing query plans input from a query plan optimizer, identifying a suboptimal query plan among the input query plans, and applying corrective actions to reoptimize the identified suboptimal query plan before execution.

### BACKGROUND

Users can request access to data by submitting a query to a database system, such as an Enterprise Data Warehouse (EDW). Queries can be executed in a number of manners, and some may be more efficient than others. An optimizer can utilize a variety of statistics to analyze a users' query and/or in optimizing possible query plans.

### BRIEF DESCRIPTION OF THE DRAWINGS

FIG. 1 illustrates a diagram of an example of a system for query plan post optimization analysis and reoptimization according to the present disclosure.

FIG. 2 illustrates a diagram of an example computing device according to the present disclosure.

FIG. 3 illustrates an example of an environment for query plan post optimization analysis and reoptimization according to the present disclosure.

FIG. 4 illustrates an example flow chart of a method for query plan post optimization analysis and reoptimization according to the present disclosure.

### DETAILED DESCRIPTION

Organizations may utilize Enterprise Data Warehouses (EDWs), e.g., data repositories from a number of disparate sources, to store information and make it accessible within the organization. In some examples, an EDW can include a number of EDW clients, e.g., organizations, and/or functions within an organization. Each of the number of EDW clients can share resources, e.g., CPU resources, relational tables, and/or indexes, among other resources, within a particular EDW. Similarly, each of the EDW clients can have a workload which is managed by the EDW. These workloads can have varying service levels, e.g., service level agreements, that must be met. As used herein, a service level refers to the admission and execution rules for a particular service. For example, a service level can specify a particular throughput speed, e.g., 5 seconds, for processing of a query.

A server, e.g., database, in an EDW can receive queries from one or more client devices, e.g., computers, which are connected to the EDW. As used herein, a query can refer to a request to search for and/or retrieve data that is stored in a server connected to a network. A query can include a Structured Query Language (SQL) query, e.g., a query based on a computer language that is designed for the retrieval and management of data in relational database management systems. Further, a query plan can refer to an ordered series of steps performed to execute a query, e.g., access data in an SQL relational database management system. In some examples, a query plan can be presented as a query plan tree, e.g., a graphical representation displaying parallel instances of steps being performed to execute the query.

When a client, e.g., a client of the EDW, submits a particular query, an SQL compiler can produce a query plan to execute the particular query. An SQL compiler can be a process that compiles SQL statements, e.g., instructions received from a client to execute a query, into query plans. Additionally, an SQL optimizer can collaborate with the SQL compiler to generate an optimal query plan, e.g., the most efficient and/or fastest running query plan available from a plurality of possible query plans. An SQL optimizer can be a process that determines which of a plurality of possible query plans would be the most efficient, e.g., identify an optimal query plan.

Many times, an SQL optimizer identifies optimal query plans. However, periodically the SQL optimizer may identify a suboptimal query plan. As used herein, a suboptimal query plan refers to a query plan that is not the most efficient and/or fastest running query plan available from a plurality of possible query plans. A suboptimal query plan generated by a SQL compiler could take hours to complete and therefore disrupt a pre-determined service level agreement (SLA). The reasons for producing a suboptimal query plan could be inadequate statistics, cardinality estimation errors, premature exhaustion of search space due to reaching the CPU/memory limit, and/or defects in the SQL compiler.

In contrast, examples of the present disclosure allow for detection and repair of suboptimal query plans prior to execution, e.g., deployment. By detecting and repairing suboptimal query plans prior to execution, corrective steps can be implemented early enough to prevent disruption to SLAs. Further, detecting and repairing suboptimal query plans prior to execution in accordance with examples of the present disclosure can save time and expense for information technology (IT) professionals and can ensure optimal management and performance of workloads within an EDW.

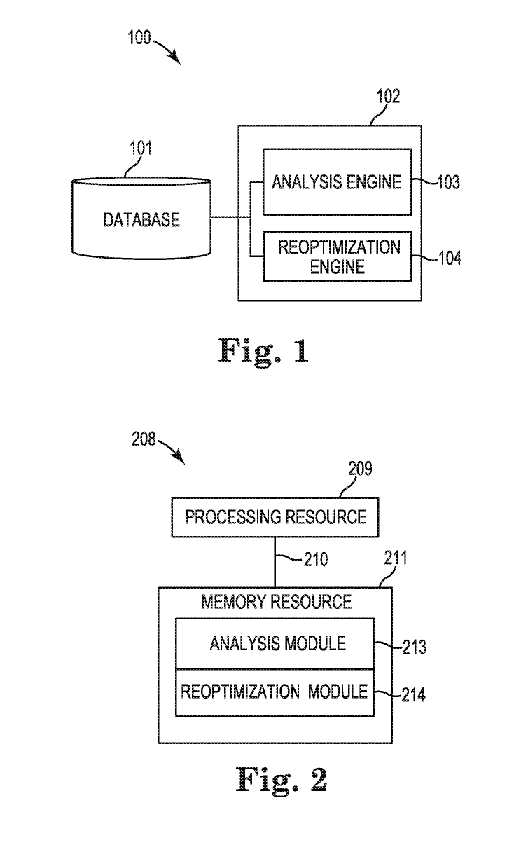

FIG. 1 illustrates a diagram of an example of a system 100 for query plan post optimization analysis and reoptimization according to the present disclosure. As shown in the example of FIG. 1, the system 100 can include a database 101 accessible by and in communication with a plurality of post optimization analysis and correction engines 102. The post optimization analysis and correction engines 102 can include an analysis engine 103, and a reoptimization engine 104, etc. The system 100 can include additional or fewer engines than illustrated to perform the various functions described herein, and embodiments are not limited to the example shown in FIG. 1. The system 100 can include hardware, e.g., in the form of transistor logic and/or application specific integrated circuitry (ASICs), firmware, and software, e.g., in the form of machine readable and executable instructions (program instructions (programming) stored in a machine readable medium (MRM)) which in cooperation can form a computing device as discussed in connection with FIG. 2.

The plurality of engines, e.g., 103, 104, as used herein can include a combination of hardware and software, e.g., program instructions, but at least includes hardware, that is configured to perform particular functions, tasks and/or actions. For example, the engines shown in FIG. 1 can be used to enable an SQL compiler to detect and correct suboptimal query plans prior to execution in an EDW and/or other network environment.

For example, the analysis engine 103 can include hardware and/or a combination of hardware and program instructions to perform a post optimization plan analysis to identify suboptimal query plans. A query plan and/or a plurality of query plans, produced by an SQL compiler and/or SQL optimizer can be input to the analysis engine 103 for post optimization plan analysis. As discussed previously, a query can be, for example, a request to search and/or retrieve data that is stored in a server, and a query plan can be a configuration for a number of operators, e.g., hardware and/or a combination of hardware and program instructions that is configured to perform a particular function, to be executed in an EDW to respond to a query. For instance, a join operator can include hardware and/or a combination of hardware and program instructions that is configured to perform a join function, e.g., identifying and joining all tuples satisfying a number user-specified join conditions. As used herein, a tuple can refer to a piece of data. For example, a data stream including a stream of events from traffic sensors and a data stream containing information from a number of weather monitor sensors, can be joined based on location, e.g., the common attribute between the two streams, to predict the probability of accidents due to bad weather conditions in real time. Other examples of operators can include a scan operator, e.g., hardware and/or a combination of hardware and program instructions to scan all tuples and search for a particular condition, a sort operator, e.g., hardware and/or a combination of hardware and program instructions to sort tuples into either ascending or descending order, and a groupby operator, e.g., hardware and/or a combination of hardware and program instructions to group all tuples based on user-specified criteria, among other operators.

The analysis engine 103 can identify suboptimal query plans from the query plans input from the SQL compiler and/or SQL optimizer. As used herein, an optimal query plan can be a query plan that includes a lowest cost, e.g., an amount of network and/or memory resource utilization, the amount of data to be processed, the amount of data to be read from the disks, and/or an amount of time needed for execution, for executing the query associated with the query plan. A suboptimal query plan can be a query plan that does not have the lowest cost, e.g., is not the most efficient and/or fastest running query plan, among a plurality of possible query plans that could be executed.

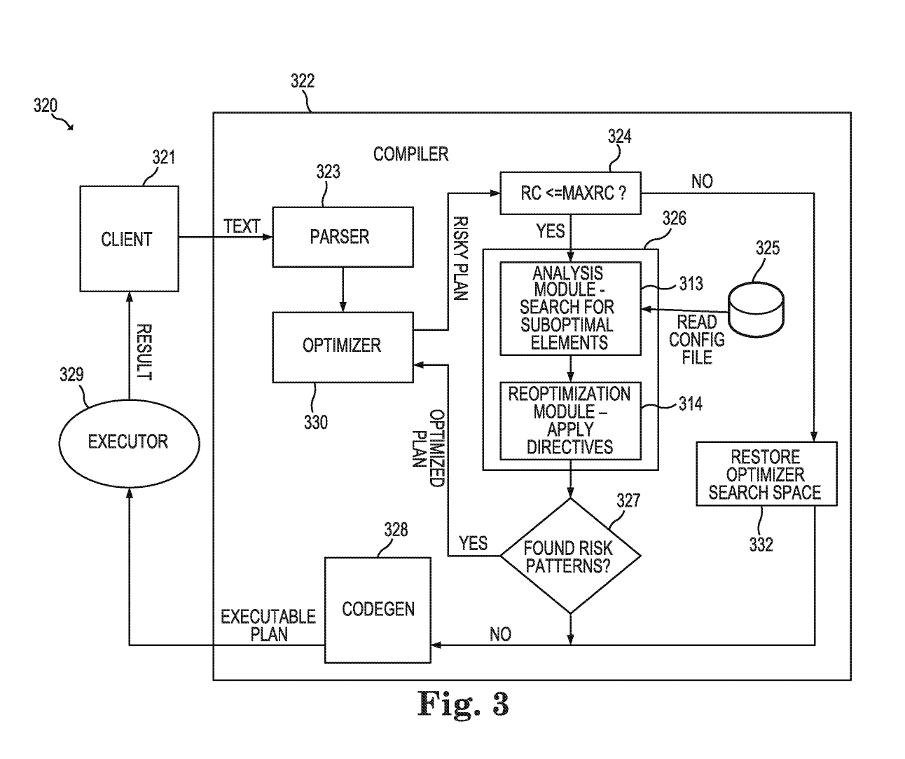

In some examples, a user and/or administrator of the EDW can specify patterns that can be used to identify suboptimal query plans. For instance, for each operator in a query plan, a user can specify conditions, e.g., name of a table and/or column, the degree of parallelism (DoP), input or output size (rows), the unique entry count (UEC), the number of file opens (OPENS), and/or the number of predicates attached to a column, and values associated with those conditions that are associated with a suboptimal query plan. As discussed further in connection with FIG. 3, elements, e.g., the operator, the condition, and the corrective action, of a suboptimal query plan can be defined by a user and/or administrator in a config file, e.g., a configuration file, which includes information relating to the operator, condition, and corrective action necessary to correct each suboptimal query plan element.

The reoptimization engine 104 can include hardware and/or a combination of hardware and program instructions to reoptimize an identified suboptimal query plan before execution. Once an SQL compiler and/or SQL optimizer generates a list of optimized query plans, the analysis engine 103 can identify suboptimal query plans from among the optimized query plans generated. In some examples, the reoptimization engine 104 can be executed by the SQL compiler itself. The reoptimization engine 104 can apply directives, e.g., corrective actions, identified in a config file to the particular operator associated with the suboptimal query plan. As described more in connection with FIG. 3, corrective actions can include applying existing SQL optimizer control switches to avoid the identified suboptimal query plan, and/or overriding a cost comparison step during the optimization performed by the SQL optimizer. Examples are not so limited, however, and other corrective actions can be executed in response to identifying elements of a suboptimal query plan, as discussed in connection with FIG. 3.

The embodiments are not limited to the example engines shown in FIG. 1 and one or more engines described may be combined or be a sub-engine of another engine. Further, the engines shown may be remote from one another in a distributed computing environment, cloud computing environment, etc.

FIG. 2 illustrates a diagram of an example computing device 208 according to the present disclosure. The computing device 208 can utilize hardware, software (e.g., program instructions), firmware, and/or logic to perform a number of functions described herein. The computing device 208 can be any combination of hardware and program instructions configured to share information. The hardware, for example, can include a processing resource 209 and/or a memory resource 211, e.g., computer or machine readable medium (CRM/MRM), database, etc. A processing resource 209, as used herein, can include one or more processors capable of executing instructions stored by a memory resource 211. The processing resource 209 may be implemented in a single device or distributed across multiple devices. The program instructions, e.g., computer or machine readable instructions (CRI/MRI)) can include instructions stored on the memory resource 211 and executable by the processing resource 209 to perform a particular function, task and/or action, e.g., analyze query plans input from a query plan optimizer and identify a suboptimal query plan among the input query plans.

The memory resource 211 can be a non-transitory machine readable medium, including one or more memory components capable of storing instructions that can be executed by processing resource 209 and may be integrated in a single device or distributed across multiple devices. Further, memory resource 211 may be fully or partially integrated in the same device as processing resource 209 or it may be separate but accessible to that device and processing resource 209. Thus, it is noted that the computing device 208 may be implemented on a participant device, on a server device, on a collection of server devices, and/or a combination of a participant, e.g., user, device and one or more server devices as part of a distributed computing environment, cloud computing environment, etc.

The memory resource 211 can be in communication with the processing resource 209 via a communication link, e.g., a path, 210. The communication link 210 can provide a wired and/or wireless connection between the processing resource 209 and the memory resource 211.

In the example of FIG. 2, the memory resource 211 can include an analysis module 213, and a reoptimization module 214. As used herein, a “module” can include hardware and software, e.g., program instructions, but includes at least program instructions that can be executed by a processing resource, e.g., processing resource 209, to perform a particular task, function and/or action. The plurality of modules 213, 214 can be independent modules or sub-modules of other modules. As shown in FIG. 2, the analysis module 213 and the reoptimization module 214 can be individual modules located on one memory resource or can be located at separate and distinct memory resource locations, e.g., in a distributed computing environment, cloud computing environment, etc.

Each of the plurality of modules 213, 214 can include instructions that when executed by the processing resource 209 can function as a corresponding engine as described in connection with FIG. 1. For example, the analysis module 213 can include instructions that when executed by the processing resource 209 can function as the analysis engine 103 shown in FIG. 1. Additionally, the reoptimization module 214 can include instructions that when executed by the processing resource 209 can function as the reoptimization engine 104 shown in FIG. 1.

In some examples, the analysis module 213 can input to a post optimization analyzer, an optimized query plan generated by an SQL optimizer. Further, in some examples, the analysis module 213 can perform a post optimization plan analysis to identify a suboptimal query plan. For instance, the analysis module 213 can search a hash table storing information defining an operator, a condition, and a corrective action associated with a suboptimal query plan, in order to identify a suboptimal query plan. The analysis module 213 can search optimized query plans received from the SQL optimizer starting with a root of the optimized query plan, and ending with a leaf of the optimized query plan. As discussed further herein, content of the hash table can be read from a configuration file within an SQL compiler.

In some examples, the reoptimization module 214 can apply corrective actions to reoptimize the identified suboptimal query plan prior to execution of the identified suboptimal query plan. Further, the reoptimization module 214 can reconfigure an SQL optimizer with corrective actions identified from the hash table, reoptimize the suboptimal query plan a number of times, and send the reoptimized query plan to an executor in a database system for execution, such as in an EDW.

Embodiments are not limited to the example modules shown in FIG. 2 and in some cases a number of modules can operate together to function as a particular engine. Further, the engines and/or modules of FIGS. 1 and 2 can be located in a single system and/or computing device or reside in separate and distinct locations in a distributed network, computing environment, cloud computing environment, etc.

FIG. 3 illustrates an example of an environment 320 for query plan post optimization analysis and reoptimization according to the present disclosure. As illustrated in FIG. 3, an EDW client 321 can submit a query, e.g., an SQL query, to an SQL compiler 322. As described further herein, an SQL compiler 322 can compile a query, e.g., an SQL query, and generate a query plan. The SQL compiler 322 can include a number of components and/or phases that perform different actions or functions. For instance, as illustrated in FIG. 3, the SQL compiler 322 can include a parser 323, an SQL optimizer 330, and/or a code generator, e.g., codegen, 328. The parser 323, e.g., an SQL parser, can provide support for parsing, splitting, and/or formatting SQL statements. The SQL optimizer 330 can identify optimal query plans. To identify an optimal query plan, the SQL optimizer 330 can perform a comparison of estimated costs of candidate (e.g., possible) query plans. The codegen 328 can generate and output an executable plan from the optimized and/or reoptimized query plan generated by the SQL optimizer 330 and/or the post optimization analysis and correction phase 326. As illustrated in FIG. 3, the post optimization analyzer 326 can include an analysis module 313 and a reoptimization module 314.

As illustrated in FIG. 3, the SQL optimizer 330 can send, e.g., output, optimized query plans to a post optimization analyzer 326. The output optimized query plans can include risky query plans. A risky query plans can be optimized query plans that may include patterns associated with a suboptimal query plan. The post optimization analyzer 326 can include hardware and/or program instructions to detect and correct suboptimal query plans prior to execution in an EDW and/or other network environment, as described in relation to FIGS. 1 and 2. For instance, the post optimization analyzer 326 can include an analysis module 313 (e.g., analysis module 213 as described in FIG. 2 and/or analysis engine 103 as described in FIG. 1), and a reoptimization module 314 (e.g., reoptimization module 214 as described in FIG. 2 and/or reoptimization engine 104).

In a number of examples, optimized query plans generated by the SQL optimizer 330 can be sent to the post optimization analyzer 326 and analyzed to identify suboptimal query plans based on user-specified conditions. For example, users of the EDW system can define in a production environment and store in a configuration file, e.g., config file 325, what constitutes suboptimal query plans.

Users, customers, or database administrators (hereinafter referred to as “users”) can learn behavior of query plans produced by the SQL optimizer 330 through knowledge discovery over the course of product usage. Using this knowledge, the users can gain insight about risk patterns, and based on the type of risk, can define conditions for operators which can lead to suboptimal plans. A user can specify each suboptimal query plan in a tuple form, such as: {<Operator>, <Condition>, <Action>}. That is, each tuple identifying a suboptimal query plan can define an operator, a condition associated with the operator, and an action to be taken if such conditions are satisfied. The <Operator> portion of the tuple can specify an operator, e.g., a relational operator, such as a scan operator, a join operator, or a sort operator, that can be found in a query plan tree. In some examples, the <Operator> portion of the tuple can further be defined by a suffix of LC, e.g., left-child, or RC, e.g., right-child, to indicate the left or right child of the operator, as represented in the query plan tree. The <Condition> portion of the tuple can describe elements of the suboptimal query plan in detail through a Boolean expression of attributes and thresholds. An attribute, as used herein, can be the name of a table or a column, the degree of parallelism (DoP) of the operator, input or output size in number of rows, a unique entry count (UEC), a number of file opens (OPENS), or a number pf predicates attached to a column. A threshold for an attribute, as used herein, can be an empirical value specific to the attribute and beyond which the particular operator performs in what the user would define as a suboptimal manner. For example, a serial plan that processes an excessive number of rows in one process can be expressed in tuple form as:

{root, DoP=1 and InputRows>1000000, <action>}

That is, the root operator, can have a condition including two attributes and associated values: DoP equal to 1, and input size greater than 1000000 rows. If the condition is satisfied for the root operator, e.g., the DoP is equal to 1 and the input size is greater than 1000000 rows, then a particular action can be taken.

The <action> portion of the tuple can specify a corrective action for the SQL compiler 322 to take, in response to identifying that the conditions for a particular operator are satisfied. Corrective actions can include applying existing SQL optimizer control switches, and/or overriding the cost comparison during pruning, e.g., as performed by the SQL optimizer 330. For example, a corrective action can include an instruction to the SQL optimizer 330 to avoid identifying a query plan meeting the conditions specified in the suboptimal query plan as an optimal query plan, despite the outcome of a cost comparison against other possible query plans. Some other examples of corrective actions can include a PARALLEL instruction, e.g., an instruction to produce a parallel plan regardless of cost, for the relational operator; a SORT instruction, e.g., an instruction to sort the output rows for the relational operator; and/or an NO-MDAM SCAN instruction, e.g., an instruction to perform a regular scan for particular relational operator.

As illustrated in FIG. 3, at 326 the post optimization analyzer 326 can search for suboptimal query plans and take corrective actions. For example, the post optimization analyzer 326 can search a hash table read from the configuration file 325 and identify whether any portion of optimized query plans received from the SQL optimizer 330 include elements, e.g., an operator and/or a condition, associated with a suboptimal query plan. The configuration file 325 contains suboptimal query plan elements, listed in text format. The post optimizer analyzer 326 can read these elements prior to query plan analysis and build a hash table in memory for subsequent use. In some examples, the post optimization analyzer 326 can search optimized query plans received from the SQL optimizer 330 starting at the root of the query plan tree, e.g., the last operator and/or operators to be executed in the query plan. For every operator included in the query plan tree, the post optimization analyzer 326 can perform a hash table lookup to identify whether that particular operator is associated with any suboptimal query plans. If the post optimization analyzer 326 identifies that an operator within the query plan tree is associated with a suboptimal query plan, the post optimization analyzer 326 can compare details of the operation of the identified operator with the attributes and values stored in the <Condition> portion of the tuple associated with the particular operator. For example, the post optimization analyzer 326 can identify that an MDAM scan operator is included in a query plan tree, and that a MDAM scan operator is associated with a suboptimal query plan. The post optimization analyzer 326 can then compare the details of operation of the MDAM scan operator in the query plan tree to the conditions associated with the MDAM scan operator, as defined in the hash table read from the configuration file 325. Based on the comparison, the post optimization analyzer 326 can determine that the suboptimal query plan and the query plan tree, e.g., the optimized query plan received from the SQL optimizer 330, both include an attribute and value wherein a UEC is greater than 20. In response to determining that the conditions associated with the suboptimal query plan are satisfied, the post optimization analyzer 326, using the reoptimization module 314, can execute the corrective action defined in the <action> portion of the tuple stored in the hash table in the configuration file 325. For instance, the post optimization analyzer 324 can provide a NO-MDAM SCAN instruction to the SQL compiler 322.

As illustrated in FIG. 3, at 327, in response to determining that elements of a suboptimal query plan are included in an optimized query plan received from the SQL optimizer 330, and taking corrective actions stored in a hash table in the configuration file 325, the post optimization analyzer 326 can send the reoptimized query plan back to the SQL optimizer 330 for further analysis, e.g., further analysis by the post optimization analyzer 326. However, if no suboptimal elements are found in the query plan tree, e.g., the optimized query plan received from the SQL optimizer 330 does not include elements associated with a suboptimal query plan, then the post optimization analyzer 326 can send the optimized query plan to the codegen 328 for execution. Before a query plan is analyzed for a first or subsequent time by the post optimization analyzer 326, a reoptimization counter 324 can compare a reoptimization count (RC) against a maximum reoptimization count (MAX_RC) threshold. The RC can be a numerical value representing the number of times that the post optimization analyzer 326 has analyzed a particular query plan. Similarly, the MAX_RC can be a user-defined threshold representing a number of times that a particular query plan can be analyzed by the post optimization analyzer 326. As illustrated in FIG. 3, if the reoptimization count is less than or equal to the maximum reoptimization count (e.g., if RC<=MAX_RC), then the query plan sent from the SQL optimizer 330 will be analyzed by the post optimization analyzer 326. Similarly, if the reoptimization count is greater than the maximum reoptimization count (e.g., if RC>MAX_RC), then the SQL compiler 322 will restore the SQL optimizer search space at 332, and the optimized query plan sent from the SQL optimizer 330 will be sent to the codegen 328. The codegen 328 can generate an executable query plan for implementation in the EDW, which can be sent to an executor 329 for physical execution in the EDW, and the results of the query can be sent to the client 321.

While FIG. 3 illustrates an SQL compiler 322 having a parser 323, an optimizer 330, a config file 325, a post optimization analyzer 326, and a codegen 328, examples are not so limited, and the SQL compiler 322 can include additional and/or fewer components than illustrated.

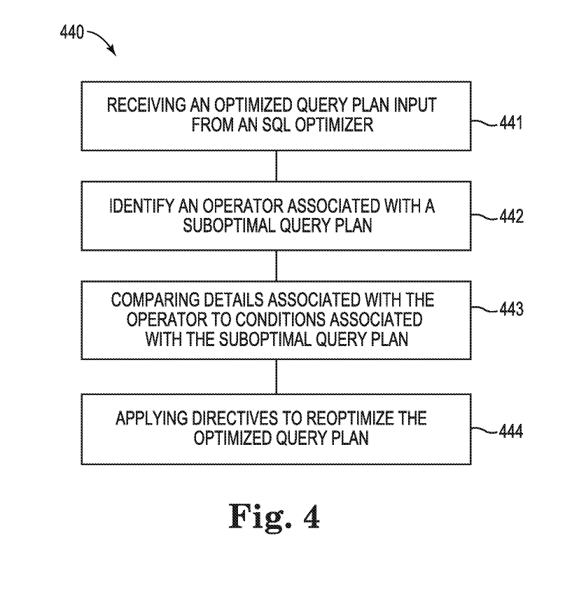

FIG. 4 illustrates an example flow chart of a method 440 for query plan post optimization analysis and reoptimization according to the present disclosure. In various examples, the method 440 can be performed using the system 100 shown in FIG. 1, or the computing device and modules shown in FIG. 2. Examples are not, however, limited to these example systems, devices, and/or modules.

At 441, the method 440 can include receiving an optimized query plan input from a SQL optimizer. For example, the SQL optimizer (330 illustrated in FIG. 3) can input optimized query plans to a post optimization analyzer (326 illustrated in FIG. 3). Both the SQL optimizer and post optimization analyzer 326 can be contained in and/or executed by an SQL compiler (322 illustrated in FIG. 3). In some examples, receiving an optimized query plan from a SQL optimizer can include receiving an optimized query plan for further analysis plus a set of corrective actions influencing the optimizer.

At 442, the method 440 can include performing post optimization plan analysis to identify operators associated with a suboptimal query plan. For example, a post optimization analyzer, e.g., a post optimization plan analysis and correction phase of a SQL compiler, can compare elements in optimized query plans received from the SQL optimizer against patterns defined by a user and stored in a configuration file in the SQL compiler. A pattern, as used herein, can refer to a user defined pattern that identifies an operator and a condition associated with that operator that can be used to identify an element of a suboptimal query plan. An element of a suboptimal query plan can be identified when all of the conditions associated with that pattern are met. Some examples of suboptimal query plan patterns, as well as the conditions associated with them are as follows:

| Suboptimal | | | Corrective |
|---|---|---|---|
| Element | Operator | Condition | Action |
| MDAM SCAN | SCAN | MDAM WHERE KEY | NO-MDAM SCAN |
| operator performing | | UEC > 20 AND | |
| too many IOs | | PRED: EMPTY | |
| Serial plan to | ROOT | InputRows > 100000 | PARALLEL |
| process 400 mil | | AND DoP = 1 | |
| rows | | | |
| Serial plan with too | ROOT | OPENS > 1000 AND | PARALLEL |
| many opens | | DoP = 1 | |
| Left child of tuple | TUPLE | leftChild.sorted = | SORT |
| flow operator not | FLOW | FALSE | |
| sorted | | | |

The post optimization plan analysis and correction phase can be executed from root to leaf of an optimized query plan. That is, the post optimization plan analysis and correction phase is executed for every operator included in a query plan, beginning with the last operator to be executed in the query plan and ending with the first operator to be executed in the query plan (e.g., the optimized plan tree is traversed from root to leaf).

At 443, the method 440 can include comparing details associated with an operator identified as being potentially associated with a suboptimal query plan, to conditions defining the suboptimal query plan. For example, as discussed in connection with FIG. 3, a hash table lookup can be performed to identify if any of the operators included in an optimized query plan are associated with a suboptimal query plan. Once an operator within an optimized query plan is identified as an operator that may be associated with a suboptimal query plan, details associated with the operator can be compared against conditions defining the suboptimal query plan. For instance, a post optimization analyzer (324 shown in FIG. 3) can determine if the OPENS for a serial plan operator are greater than 1000 and the DoP for the serial plan operator is equal to one. If both of those conditions are met, then the optimized query plan can be identified as a suboptimal query plan, e.g., the optimized query plan includes elements of a suboptimal query plan.

At 444, the method 440 can include applying directives to reoptimize the optimized query plan in the optimizer before execution in an EDW, in response to determining that all conditions defining a suboptimal query plan are satisfied. For example, as discussed in relation to FIG. 3, a user can define conditions associated with a suboptimal query plan. Definitions defining suboptimal query plans can be defined in a hash table stored in a configuration file. In some instances, applying directives to reoptimize the optimized query plan can include providing instructions to a SQL optimizer to override a cost comparison for the identified suboptimal query plan. For example, to avoid a serial plan, the PARALLEL instruction can be provided. This instruction can set the query plan priority to high so that the parallel version of the operator will not be pruned off, e.g., excluded from execution, due to poor cost estimation. However, examples are not so limited, and any action defined by a user and stored in the configuration file can be used to reoptimize a suboptimal query plan. In some examples, once directives, e.g., corrective actions, have been applied by the SQL compiler to reoptimize a suboptimal query plan, the directives can be reset to normal operation. For instance, if a corrective action included applying optimizer control switches to avoid searching in a particular area of optimization, once the query that included the suboptimal query plan elements initially has been found optimal, the SQL compiler can remove the optimizer control switch and allow subsequent queries to search the entire EDW.

While FIGS. 3 and 4 discuss query plan post optimization analysis wherein a single suboptimal query plan element is identified within an optimized query plan, examples are not so limited. For example, an optimized query plan can include a plurality of operators, some of which are executed in parallel. Within the optimized query plan, a plurality of suboptimal query plan elements can be identified. For instance, a scan operator within the optimized query plan can be associated with a first suboptimal query plan and a join operator within the optimized query plan can be associated with a second suboptimal query plan.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed is:

1. A system for query plan post optimization analysis and reoptimization, comprising:
an analysis engine to analyze query plans input from a query plan optimizer and identify a suboptimal query plan among the input query plans; and
a reoptimization engine to apply corrective actions to reoptimize the identified suboptimal query plan before execution.

2. The system of claim 1, including the analysis engine to identify the suboptimal query plan based on user-specified conditions associated with operators included in the suboptimal query plan.

3. The system of claim 2, wherein elements of the suboptimal query plan and corrective action are defined in a config file.

4. The system of claim 1, wherein the analysis engine and the reoptimization engine are executed by a structured query language (SQL) compiler.

5. A non-transitory computer readable medium storing instructions executable by a processing resource to cause a computer to:
input to a post optimization analyzer, an optimized query plan generated by a standard query language (SQL) optimizer;
perform a post optimization plan analysis to identify a suboptimal query plan; and
apply corrective actions to reoptimize the identified suboptimal query plan prior to execution of the identified suboptimal query plan.

6. The non-transitory computer readable medium of claim 5, wherein the instructions executable to perform a post optimization plan analysis to identify a suboptimal query plan, include instructions to search a hash table storing information defining an operator, a condition, and a corrective action associated with the suboptimal query plan.

7. The non-transitory computer readable medium of claim 6, wherein content of the hash table is read from a configuration file within the SQL compiler.

8. The non-transitory computer readable medium of claim 6, wherein the instructions to search a hash table storing information defining an operator, a condition, and a corrective action associated with the suboptimal query plan, include instructions to search the optimized query plan received from the SQL optimizer starting with a root of the optimized query plan.

9. The non-transitory computer readable medium of claim 6, including instructions to:
reconfigure the SQL optimizer with the corrective action;
reoptimize the suboptimal query plan a number of times; and
send the reoptimized query plan to an executor in a database system for execution, wherein the database system is an enterprise data warehouse (EDW).

10. A method for query plan post optimization analysis and reoptimization, comprising:
receiving an optimized query plan input from a structured query language (SQL) optimizer;
performing a post optimization plan analysis to identify an operator associated with a suboptimal query plan within the optimized query plan;
comparing details associated with the operator to conditions defining the suboptimal query plan, in response to identifying that the operator is an operator that is associated with the suboptimal query plan; and
applying directives to reoptimize the optimized query plan before execution in an enterprise database warehouse (EDW), in response to determining that all conditions defining the suboptimal query plan are satisfied by the details associated with the operator.

11. The method of claim 10, wherein receiving an optimized query plan input from the SQL optimizer includes receiving a reoptimized query plan for further analysis.

12. The method of claim 10, wherein performing a post optimization plan analysis to identify an operator associated with a suboptimal query plan within the optimized query plan includes performing the post optimization plan analysis from root to leaf in the optimized query plan.

13. The method of claim 10, wherein performing a post optimization plan analysis to identify an operator associated with a suboptimal query plan includes performing a hash table lookup for every operator included in the optimized query plan.

14. The method of claim 10, wherein applying directives to reoptimize the optimized query plan before execution in the EDW includes overriding a cost comparison by the SQL optimizer.

15. The method of claim 10, including executing the reoptimized query plan in the EDW and returning results of the reoptimized query plan to a user of the EDW.
